(19) United States
(12) Patent Application Publication
(10) Pub. No.: US 2026/0170416 A1
(43) Pub. Date: Jun. 18, 2026

(54) PERSONALIZED RECONFIGURABLE INTELLIGENT SURFACE-ASSISTED OVER-THE-AIR FEDERATED LEARNING TO TRAIN GLOBAL AND PERSONALIZED MODELS

(71) Applicant: Ohio State Innovation Foundation, Columbus, OH (US)

(72) Inventors: Jiayu Mao, Columbus, OH (US); Aylin Yener, Columbus, OH (US)

(21) Appl. No.: 19/416,886

(22) Filed: Dec. 11, 2025

Related U.S. Application Data
(60) Provisional application No. 63/734,442, filed on Dec. 16, 2024.

(51) Int. Cl. G06N 20/00

(52) U.S. Cl. CPC G06N 20/00

(57) ABSTRACT

Systems and methods are described for personalized reconfigurable intelligent surface (RIS)-assisted over-the-air federated learning (OTA-FL) to train global and personalized models. A method may include obtaining, as a local model at a client, a global model from a server and performing a first training on the local model at the client using local data to update global parameters. The method may also include transmitting, from the client to the server, updates of the global parameters resulting from the first training, and performing, subsequent to the transmitting, a second training at the client to generate a personalized model.

### CROSS-REFERENCE TO RELATED APPLICATIONS

This application claims priority under 35 U.S.C. § 119(e) to Provisional Patent Application No. 63/734,442, filed Dec. 16, 2024, the entire contents of which are hereby incorporated herein by reference.

### GOVERNMENT LICENSE RIGHTS

This invention was made with government support under CNS-2112471 awarded by the National Science Foundation (NSF). The government has certain rights in the invention.

### BACKGROUND

An artificial intelligence (AI) (e.g., machine learning (ML)) model requires training to function effectively for an intended task. The volume of data and the time required to adequately train the model can be onerous. Federated learning is a technique by which a number of clients collaboratively train the same model, thereby distributing the burden of obtaining training data and facilitating parallel, local training at each client to save time. Each of the clients begins with the same global model provided by a coordinating server, performs local training based on locally available training data, and provides updated parameters resulting from the local training to the server. The server uses the updated parameters to generate and distribute an updated global model that is used for a subsequent round of local training. This process continues iteratively until the global model converges.

### SUMMARY

Certain aspects of the concepts and embodiments described herein are summarized below. The aspects are representative and not exhaustively listed. In alternate embodiments, certain features and elements can be added, omitted, and interchanged with each other. Additionally, variations, extensions, and modifications to the example embodiments can be achieved by those skilled in the art without departing from the concepts, so as to encompass equivalent and related structures.

Various embodiments are disclosed for personalized reconfigurable intelligent surface (RIS)-assisted over-the-air federated learning (OTA-FL) to train global and personalized models. An example method includes obtaining, as a local model at a client, a global model from a server, performing a first training on the local model at the client using local data to update global parameters, and transmitting, from the client to the server, updates of the global parameters resulting from the first training. The method also includes performing, subsequent to the transmitting, a second training at the client to generate a personalized model.

In some aspects, the method includes transmitting, from the client to a reconfigurable intelligent surface (RIS) for reflection to the server, the updates of the global parameters resulting from the first training. The method may also include designing phase shifts of the RIS. In some aspects, the method includes determining a number of steps in the first training based on a transmit power budget of the client. The transmitting the updates of the global parameters may be simultaneous with transmissions from one or more additional clients to the server, and the transmitting from the client and the transmissions from the one or more additional clients may generate an updated global model at the server based on over-the-air aggregation of the updates of the global parameters from the client and the one or more additional clients.

In some aspects, the method also includes one or more iterations of: receiving, as an updated local model at the client, the updated global model from the server, performing the first training of the updated local model at the client to update the global parameters, and transmitting, from the client to the server, updates of the global parameters resulting from the first training. A number of the one or more iterations may be based on convergence of the global model. In some aspects, the performing the second training is on a result of the first training.

In some aspects, the client is one of a plurality of clients obtaining the global model from the server, performing the first training to update the global parameters, and transmitting the updates of the global parameters resulting from the first training to the server. The method may include each of the plurality of clients using a respective reconfigurable intelligent surface (RIS) to reflect, to the server, the updates of the global parameters resulting from the first training. In some aspects, the method may also include each of the plurality of clients performing a respective number of steps in the first training that is based on an estimate of channel state information (CSI) at each of the plurality of clients. The number of steps in the first training performed by a first client among the plurality of clients may be greater than the number of steps in the first training performed by a second client among the plurality of clients with a better estimate of CSI than the first client.

An example system includes a client. The client may obtain, as a local model, a global model from a server, perform a first training on the local model using local data to update global parameters, transmit, to the server, updates of the global parameters resulting from the first training, and perform, subsequent to transmitting the updates, a second training to generate a personalized model.

In some aspects, the client transmits, to a reconfigurable intelligent surface (RIS) for reflection to the server, the updates of the global parameters resulting from the first training. The client may design phase shifts of the RIS. The client may determine a number of steps in the first training based on a transmit power budget of the client. In some aspects, the client may transmit the updates of the global parameters simultaneously with transmissions from one or more additional clients to the server. Transmission from the client and the transmissions from the one or more additional clients may generate an updated global model at the server based on over-the-air aggregation of the updates of the global parameters from the client and the one or more additional clients.

In some aspects, the client performs one or more iterations of: receiving, as an updated local model, the updated global model from the server, performing the first training of the updated local model to update the global parameters, and transmitting, to the server, updates of the global parameters resulting from the first training. A number of the one or more iterations may be based on convergence of the global model. The client may perform the second training on a result of the first training.

In some aspects, the client may be one of a plurality of clients to obtain the global model from the server, perform the first training to update the global parameters, and transmit the updates of the global parameters resulting from the first training to the server. Each of the plurality of clients may use a respective reconfigurable intelligent surface (RIS) to reflect, to the server, the updates of the global parameters resulting from the first training. A number of steps in the first training performed by each of the plurality of clients may be based on an estimate of channel state information (CSI) at each of the number of clients, and the number of steps in the first training performed by a first client among the plurality of clients may be greater than the number of steps in the first training performed by a second client among the plurality of clients with a better estimate of CSI than the first client.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views. Repetition of labels for some components may be omitted for clarity of the illustrations.

FIG. 1 is a block diagram of a system to perform reconfigurable intelligent surface (RIS)-assisted over-the-air federated learning (OTA-FL) to train a global model and one or more personalized models according to various embodiments.

FIG. 2 is a process flow of a method of performing RIS-assisted OTA-FL for training a global model and one or more personalized models according to various embodiments.

FIG. 3 is a block diagram of detailing aspects of processing circuitry that may be part of the parameter server and each of the clients according to various embodiments.

### DETAILED DESCRIPTION

As previously noted, federated learning is a technique for distributed training of an AI model by a number of collaborating edge devices, which can be referred to as clients, in communication with a coordinating server, which can be referred to as a parameter server. As also noted, the parallel training at each of the clients using local data can distribute the task of obtaining training data and facilitate faster, parallel training. The local training based on decentralized, local data at each of the clients can address data privacy and data access rights issues, as well as promote data minimization. That is, each client may belong to a separate entity and/or have access to training data that must be secured. Thus, by providing only updated parameters rather than sharing training data, each entity can help maintain data security while contributing to the training of the global model.

On the other hand, the decentralization of training data increases the likelihood that the training data used across the clients in federated learning is not independent and identically distributed (i.e., the training data is non-iid). To address issues of unbalanced and non-iid data across the clients, a federated averaging algorithm using weighted inputs may be used for global model aggregation, for example. However, limited communication bandwidth is a bottleneck for aggregating the locally computed updates that are wirelessly communicated from the clients to the parameter server.

In this regard, over-the-air federated learning (OTA-FL) is seen as an approach to fast global model aggregation. OTA-FL takes advantage of the intrinsic superposition property of a wireless multiple-access channel. That is, the clients simultaneously transmit their updates and the parameter server directly receives the aggregated model based on the superposition of the updates over the air. However, this aggregation via superposition requires proper power control of each transmission, which in turn relies on channel state information (CSI) at each transmitting client. CSI takes into account the combined effect of characteristics such as scattering, fading, power decay with distance, and the like, to provide an indication of how a signal will propagate from a transmitter to a receiver.

In this context, OTA-FL using personalized reconfigurable intelligent surfaces (RIS) is described. A RIS is a two-dimensional surface with elements that can be configured to control the phase of signals reflected from each of the elements. This allows control of the direction and shape of the reflected signal and improved wireless link quality. According to various embodiments described herein, each client transmits updated model parameters directly to the parameter server and also indirectly via reflection from an associated, personalized RIS. This use of the personalized RIS by each client facilitates higher tolerance to imperfect CSI and resulting sub-optimal power control of the transmitted signal.

As noted, OTA-FL facilitates collaborative training of a global model via local training of the global model provided by the parameter server to clients. That is, each round of training begins with the parameter server providing an initial or updated global model to the clients for local training. The local copy of the global model at each client may be referred to as a local model. As also noted, aspects of various embodiments involve each client using a personalized RIS to transmit updated parameters to the parameter server after each round of local training. While this process results in a trained global model, some applications may benefit from specialized training for a particular task.

That is, additional training of a parameter, which can be referred to as a local parameter, may be needed to use the model for a particular task. The resulting model can be referred to as a personalized model. As a non-limiting example for explanatory purposes, a global model may be trained for image recognition. One personalized model resulting from additional training may be directed to the task of identifying a type of animal in a conservation application. Another personalized model resulting from additional training of the same global model may be directed to the task of identifying a type of tumor in a medical application.

In this context, personalized federated learning is described. That is, one or more of the clients that participate in the OTA-FL of a global model can additionally update a local parameter for a particular task. As previously noted, the local model (used for training the global model) that is additionally trained for the particular task may be referred to as a personalized model. This bi-level approach, according to various embodiments, leverages the OTA-FL global model training for generating the personalized model at one or more clients. According to this bi-level framework, personalized model refinement can be performed at each of the clients using the global model as a foundation, thereby eliminating the need for additional global aggregation rounds dedicated to each personalized task. As a result, the system can achieve task-specific personalization with fewer OTA-FL communication rounds than approaches that rely solely on global model training for each individual task.

Aspects of RIS-assisted OTA-FL systems and methods for training a global model and one or more personalized models are detailed below according to various embodiments.

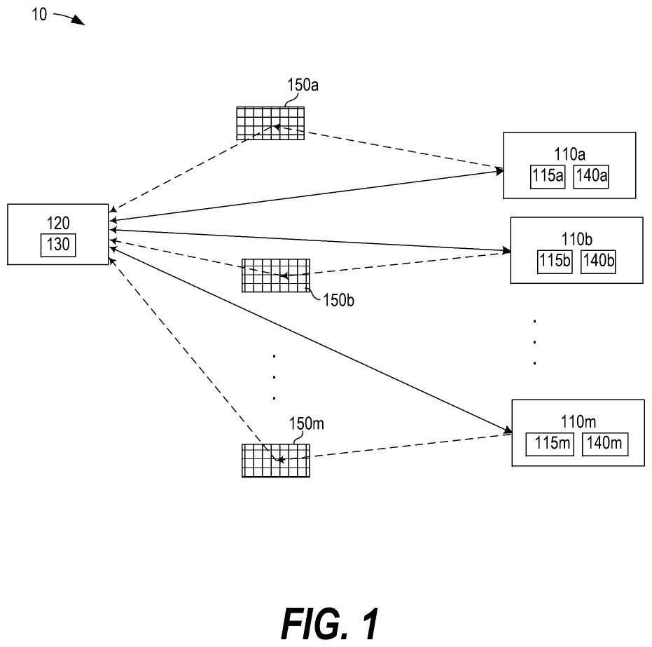

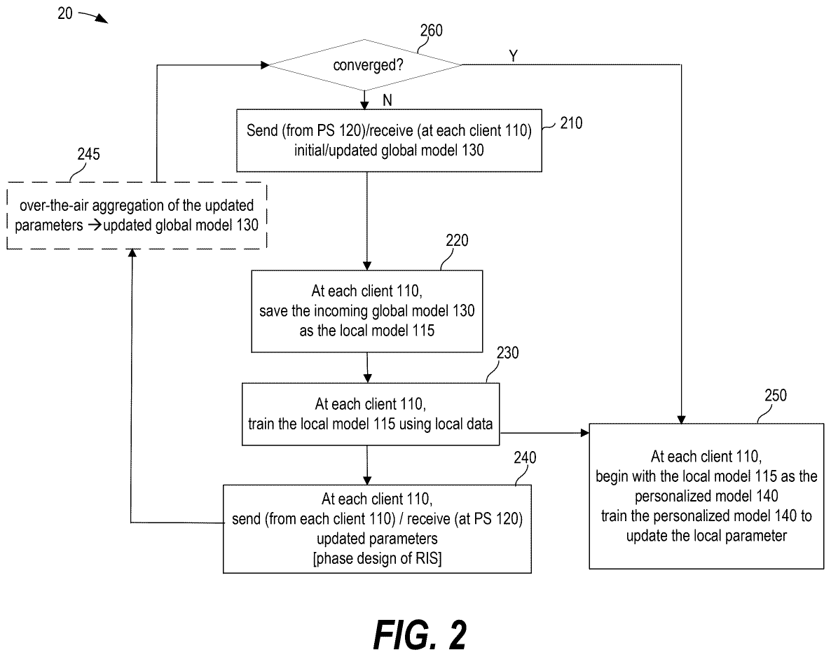

Turning to the drawings, FIG. 1 is a block diagram of an exemplary bi-level OTA-FL system 10 that facilitates collaborative training of a global model, as well as leveraged training of one or more personalized models, according to various embodiments. Clients 110a through 110m (generally referred to as client(s) 110) are shown. Clients 110a through 110m are shown with local models 115a through 115m (generally referred to as local model(s) 115) and personalized models 140a through 140m (generally referred to as personalized model(s) 140). It should be understood that every client 110 that participates in OTA-FL using a local model 115 need not have a personalized model 140. As further discussed with reference to FIG. 2, local model 115 and personalized model 140 are delineated for explanatory purposes but may refer to different training stages of the same model. A parameter server 120 is shown with a global model 130.

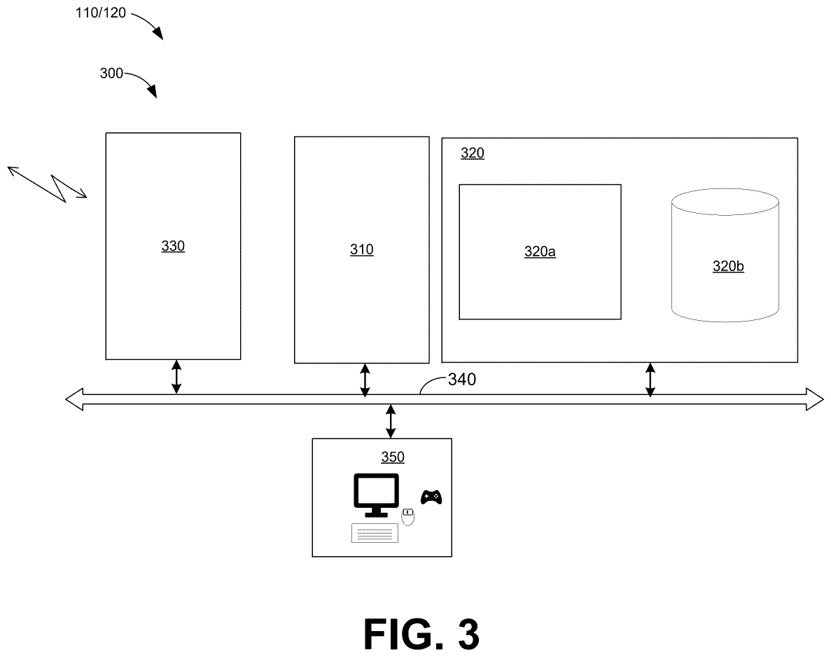

The clients 110 may generally be edge devices, and the parameter server 120 may be a service (e.g., cloud-based service) available to the clients 110. One or more clients 110 may be part of the same enterprise and one or more clients 110 may be part of different enterprises. For example, the clients 110 and parameter server 120 may all be part of the same enterprise according to non-limiting embodiments. The description herein is not intended to limit the geographic or organizational arrangement of the clients 110 and parameter server 120. As discussed with reference to FIG. 3, each client 110 and the parameter server 120 may be embodied by processing circuitry 300. One or more clients 110 and/or the parameter server 120 may share components of the processing circuitry 300 described.

As indicated in FIG. 1, each client 110 and the parameter server 120 may have bidirectional communication. That is, the parameter server 120 may transmit an initial or updated global model 130 to each client 110 and each client 110 may transmit locally generated updates to the parameter server 120. Additionally, each client 110 may transmit locally generated updates to the parameter server 120 via a corresponding personalized RIS 150, as shown. While the geographic and organizational arrangement of the clients 110 and the parameter server 120 are not intended to be limited, the physical arrangement of each RIS 150 relative to the associated client 110 may be selected to minimize interference among the transmissions from each client 110 to its associated RIS 150 and among the reflections from each RIS 150 to the parameter server 120.

FIG. 2 is a process flow of a method 20 of performing RIS-assisted OTA-FL for training a global model 130 and one or more personalized models 140 according to various embodiments. At 210, the parameter server 120 sends an initial global model 130 to each of the clients 110 at the start of the process flow. At 220, each of the clients 110 that receives the global model 130 saves that latest global model 130 as its local model 115. At 230, each of the clients 110 trains its local model 115 using local training data. As previously noted, this local training data may include secure data (e.g., pertaining to customers of the enterprise associated with the client 110) such that the data is not/cannot be shared among the clients 110 or with the parameter server 120. Based on the local training, each client 110 may obtain updated parameters, referred to as global parameters for explanatory purposes, for its local model 115.

At 240, each of the clients 110 sends updated global parameters obtained from the local training (at 230) to the parameter server 120. The processes at or prior to 240 include each client 110 controlling the phase design of its associated RIS 150. In some embodiments, a client 110 may acquire channel state information (CSI) for the current communication round and compute or refine the phase configuration of its personalized RIS 150 prior to receiving the updated global model 130 at 210. This RIS-first ordering may enable the RIS 150 of a client 110 to be configured before local training (at 230), transmission of the updated parameters (at 240), and over-the-air aggregation (at 245). At 245, the simultaneous transmission of the updated global parameters from the clients 110 may result in over-the-air aggregation to generate an updated global model 130 at the parameter server 120. At 260, a check is done for convergence of the updated global model 130. As indicated, the processes at 210 through 260 continue until the check at 260 determines that the global model 130 has converged. Convergence may be determined based on a stochastic gradient descent (SGD) result being within a threshold value, for example.

As shown in FIG. 2, the results of training the local model (at 230) are also used within each client 110 (at 250). At 250, each client 110 may save or use the trained local model 115 as a personalized model 140 and perform additional training to update a local parameter, which may refer to one or more parameters, for a particular task. By performing training of the personalized model 140 (at 250) after transmitting the updated global parameters (at 240), the clients 110 may efficiently use the time for over-the-air aggregation (i.e., generation of the updated global model 130 at the parameter server 120), which would otherwise be idle time at the clients 110. This may decrease the overall training time for the global model 130 and personalized model(s) 140.

When the parameter server 120 determines that the global model 130 has converged, based on the check at 260, the updated global model 130 may be sent to the clients 110 (at 210) with an indication of the convergence. Each client 110 may retain the updated global model 130 as a trained local model 115 and use/save the trained local model 115 as a personalized model 140 that is further trained (at 250) to update the local parameter. That is, following convergence of the global model 130, further training to update the global parameters (at 230) may be omitted and only the local parameter may be updated (at 250) to obtain a trained personalized model 140 at each client 110. The above-noted processes of the method 20 are further detailed below.

The initial global model 130 wₜ and each updated global model 130 sent in each iteration by the parameter server 120 (at 210) to each of the clients 110, indexed using i, are represented as

$${w}_{t , 0}^{i} ,$$

with t indicating the iteration (i.e., training round) among a total of T iterations. The local training (at 230) entails each client 110 i performing SGD to calculate its local gradient with the received global model 130 (i.e., local model 115) and its training dataset Di for

$${τ}_{t}^{i}$$

steps. As previously noted, the training datasets Dᵢ among the different clients 110 may be non-iid. Thus, the training dataset Dᵢ of each client 110 may have a distinct distribution χᵢ. Determination of the number of training steps

$${τ}_{t}^{i}$$

needed at each client 110 i during each iteration is discussed below.

At 240, following the local training on the received global model 130 (received at 210), each client 110 transmits a signal

$${x}_{t}^{i}$$

to the parameter server 120 (at 240) given by:

$${x}_{t}^{i} = {β}_{t}^{i} ( {w}_{t , {τ}_{t}^{i}}^{i} - {w}_{t , 0}^{i} ) \qquad [ EQ . 1 ]$$

### In EQ. 1

$${β}_{t}^{i}$$

is the power control factor for each client 110 i and may be determined according to EQ. 2 below. The value of

$${τ}_{t}^{i}$$

indicating the number of local training steps for a given iteration t, is determined at each client 110 i using the constraints indicated in EQs. 3 and 4, which relate to a power constraint based on the transmit power budget Pₜⁱ of each client 110.

$${β}_{t}^{i} = \frac{{β}_{t} {α}_{i}}{{τ}_{t}^{i} \hat{{h}_{t}^{i}}} \qquad [ EQ . 2 ]$$

$$𝔼 [ {‖ {x}_{t}^{i} ‖}^{2} ] \leq {P}_{t}^{i} \qquad [ EQ . 3 ]$$

$$3 {η}_{t}^{2} {β}_{t}^{i} {τ}_{t}^{i} {G}^{2} \leq {P}_{t}^{i} \qquad [ EQ . 4 ]$$

The number of local training steps

$$( {τ}_{t}^{i} )$$

may be determined at each client 110 prior to training the local model 115 (at 230) for each iteration t based on the constraints at EQs. 3 and 4. The power control factor

$${β}_{t}^{i}$$

for each client 110 may then be determined based on EQ. 2 to determine the signal

$${x}_{t}^{i}$$

according to EQ. 1 and transmitting to the parameter server 120 (at 240).

In EQ. 2, [symbol] is the overall estimated CSI at the client 110 i, βₜ is the power control at parameter server 120, and αᵢ is the weight of each client 110 i and is a function of the training datasets Dᵢ:

$${α}_{i} = \frac{\vert {D}_{i} \vert}{{\sum }_{i ∈ [ m ]} \vert {D}_{i} \vert} \qquad [ EQ . 5 ]$$

In EQ. 3, [symbol] denotes expectation with respect to the Euclidean norm. In EQ. 4, ηₜ is the learning rate at the client 110 i, and G is the bound of the stochastic gradient. Using the dynamic local steps,

$${τ}_{t}^{i} ,$$

counters learning degradation caused by imperfect CSI-induced misalignment. Increasing the number of local learning steps

$$( {τ}_{t}^{i} )$$

in each iteration t may reduce the total number of iterations T, thereby reducing the channel usage by reducing the number of transmissions between the clients 110 and parameter server 120. In addition, a client 110 with a poor estimated CSI need not result in all the clients 110 being penalized via an increased number of OTA FL training iterations T. Instead, the client 110 with the poor estimated CSI may perform a greater number of local learning steps

$$( {τ}_{t}^{i} )$$

in each iteration t as compared with other clients 110.

As previously noted, processes at or prior to 240 include each client 110 controlling the phase design of its associated RIS 150. For a given iteration t, the phase design of each RIS 150 i, respectively associated with each client 110 i, is given by

$${θ}_{t}^{i} ,$$

which is derived by rewriting EQ. 2 and EQ. 4 as follows:

$${( {g}_{t}^{i} )}^{H} {θ}_{t}^{i} \geq \frac{3 {η}_{t}^{2} {β}_{t} {α}_{i} {G}^{2}}{{P}_{t}^{i}} - {\hat{h}}_{UB , t}^{i} \qquad [ EQ . 6 ]$$

The phase is then designed using a minimization function as:

$$\begin{matrix}min \\ {θ}_{t}^{i}\end{matrix} {‖ {( {g}_{t}^{i} )}^{H} {θ}_{t}^{i} - \frac{3 {η}_{t}^{2} {β}_{t} {α}_{i} {G}^{2}}{{P}_{t}^{i}} - {\hat{h}}_{UB , t}^{i} ‖}_{2}^{2} \qquad [ EQ . 7 ]$$

### In EQ. 7,

$$\vert {θ}_{t , n}^{i} \vert = 1 , n = 1 , … , N .$$

EQ. 7 is non-convex and successive convex approximation (SCA) is used by first defining:

$$f ( {θ}_{t}^{i} ) = {‖ {s}_{t}^{i} - {( {g}_{t}^{i} )}^{H} {θ}_{t}^{i} ‖}_{2}^{2} = ( {s}_{t}^{i} ) * {s}_{t}^{i} - 2 {R}_{e} \{ {( {θ}_{t}^{i} )}^{H} a \} + {( {θ}_{t}^{i} )}^{H} U {θ}_{t}^{i} \qquad [ EQ . 8 ]$$

$$In EQ . 8 , a = {s}_{t}^{i} {g}_{t}^{i} , U = {{g}_{t}^{i} ( {g}_{t}^{i} )}^{H} ,$$

$$and {s}_{t}^{i} = \frac{3 {η}_{t}^{2} {β}_{t} {α}_{i} {G}^{2}}{{P}_{t}^{i}} - {\hat{h}}_{UB , t}^{i} .$$

$$Using {θ}_{n , t}^{i} = {e}^{j {∅}_{n , t}^{i}}$$

and noting that

$${s}_{t}^{i}$$

is a constant, the following is derived:

$${f}_{1} ( {∅}_{t}^{i} ) = {( {e}^{j {∅}_{t}^{i}} )}^{H} {Ue}^{j {∅}_{t}^{i}} - 2 {R}_{e} \{ {( {e}^{j {∅}_{t}^{i}} )}^{H} a \} \qquad [ EQ . 9 ]$$

### In EQ. 9,

$${∅}_{t}^{i} = {( {∅}_{1 , t}^{i} , … , {∅}_{N , t}^{i} )}^{T} ,$$

where T indicates a transform. By applying the SCA and using a second-order Taylor expansion to find the surrogate function

$$g ( {∅}_{t}^{i} , {∅}_{t , j}^{i} )$$

at point

$${∅}_{t , j}^{i}$$

in iteration j, then using SGD to find the stationary solution

$${∅}_{t , J}^{i} ,$$

$${∅}_{t , j + 1}^{i} = {∅}_{t , j}^{i} - \frac{∇ {f}_{1} ( {∅}_{t , j}^{i} )}{λ} \qquad [ EQ . 10 ]$$

As a result, the phase design of the RIS 150 corresponding with client 110 i is given by:

$${θ}_{t}^{i} = {e}^{j {∅}_{t}^{i}} \qquad [ EQ . 11 ]$$

Unlike the prior federated learning, which is directed to solving a single global objective using local objective function Fᵢ(w, D₁), the bi-level learning, according to various embodiments, also trains a local parameter vⁱ for a personalized model 140. While FIG. 2 indicates that training the personalized model 140 is performed at every client 110, it should be understood that only one or more of the clients 110 that participate in the OTA FL may additionally perform training of a personalized model 140.

The bi-level personalized federated learning involves the following minimization function:

$${min}_{{v}^{i} ∈} {R}_{i} ( {v}^{i} ; w \text{*)} {=}^{Δ} {F}_{i} ( {v}^{i} , {D}_{i} ) + \frac{λ}{2} {‖ {v}^{i} - w * ‖}^{2} \qquad [ EQ . 12 ]$$

In EQ. 12, λ is a hyperparameter of regularization. As λ approaches 0, the proximal term becomes negligible and the optimization reduces to pure training of the personalized model 140. Conversely, as λ approaches infinity, the proximal term dominates, diminishing personalization and recovering standard global-model training 130. Based on EQ. 12, each client 110 updates global parameters using its local model 115 as:

$$w *= {}_{w}^{arg min} F ( w ) \qquad [ EQ . 13 ]$$

The updated global model 130 resulting at the parameter server 120 from aggregation of the transmitted signals

$${x}_{t}^{i}$$

from each of the clients 110 (at 245) is obtained by applying the power control factor βₜ of the parameter server 120 and is given by:

$${w}_{t + 1} = {w}_{t} + \frac{1}{{β}_{t}} {\sum }_{i = 1}^{m} {h}_{t}^{i} {x}_{t}^{i} + {\tilde{z}}_{t} \qquad [ EQ . 14 ]$$

In EQ. 14, \tilde{z}ₜ represents effective additive white Gaussian noise (AWGN) for the iteration t with a zero mean and a variance of

$$\frac{{σ}_{c}^{2}}{{β}_{t}^{2}} {I}_{d} ,$$

where

$${σ}_{c}^{2}$$

is the variance of the AWGN of the received signal at the parameter server 120 and I_{d} is the identity matrix.

Local learning at each client 110 (i.e., training the local model 115 at 230) involves each client's contribution to optimizing the global objective, whereas solving the personalized objective at 250 involves minimizing Rᵢ(vⁱ; w*) by performing SGD on the local parameter for a number of personalized steps

$${τ}_{v}^{i} ,$$

initializing with

$${ν}_{t}^{i}$$

from the last global iteration. The local parameter is obtained, at each client 110 i, for each of the personalized training steps

$$( {τ}_{v}^{i} )$$

indexed by k, as:

$${v}_{t , k + 1}^{i} = {v}_{t , k}^{i} - {η}_{v} ( ∇ {F}_{i} ( {v}_{t , k}^{i} ) + λ ( {v}_{t , k}^{i} - {w}_{t} ) ) \qquad [ EQ . 15 ]$$

In EQ. 15, ηᵥ is the learning rate of the personalized training and

$${v}_{t + 1}^{i}$$

is set to

$${v}_{t , {τ}_{v}^{i}}^{i} .$$

In each iteration t, w* is approximated as wₜ and each client 110 updates its local parameter vⁱ independently (at 250) in parallel with the other clients 110.

FIG. 3 is a block diagram detailing aspects of the parameter server 120 and each of the clients 110 according to various embodiments. The parameter server 120 and the clients 110 may be implemented as a server or any other system providing computing capability or may employ a plurality of computing devices arranged, for example, in one or more server banks, computer banks, or other arrangements. The components of the parameter server 120 and the clients 110 discussed herein and otherwise known to be included are not limited to a specific number of geographic location or proximity relative to other components. For example, the parameter server 120 and the clients 110 may include a plurality of computing devices that together may comprise a hosted computing resource, a grid computing resource, and/or any other distributed computing arrangement. In some cases, the parameter server 120 and the clients 110 may correspond to an elastic computing resource where the allotted capacity of processing, network, storage, or other computing-related resources may vary over time.

The parameter server 120 and the clients 110 comprise processing circuitry 300 that may include one or more processors 310 and memory 320, including computer-readable media 320a to store instructions that are processed by one or more of the processors 310 and one or more databases 320b to store data. Computer-readable instructions should be understood as including software generated using programming languages such as, for example, C, C++, C#, Objective C, Java®, JavaScript®, Perl, PUP, Visual Basic®, Python®, Ruby, Flash®, or other programming languages. The parameter server 120 and the clients 110 may also include communication components 330 to facilitate wireless and/or wired communication via the parameter server 120 and the clients 110. Components of parameter server 120 and the clients 110 may communicate via any known local interface 340 (e.g., a data bus with an accompanying address/control bus or other bus structure). As previously noted, the components are not limited to being arranged or housed together. Thus, wireless and/or wired communication may be employed among the components of the processing circuitry 300 (e.g., local interface 340 may be implemented as a network).

Any reference to processor 310 should be understood to mean one or more of the processors 310 (implemented sequentially or in parallel), and any reference to processor 310 should be understood to refer to the same, different, or a combination of the same and different processors 310 as other references to processor 310.

One or more processors 310 may comprise technologies that include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

Memory 320 is defined herein as including both volatile and nonvolatile memory and data storage components. Volatile components are those that do not retain data values upon loss of power. Nonvolatile components are those that retain data upon a loss of power. Thus, the memory 320 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device. In the context of the present disclosure, a computer-readable medium 320b can be any medium that can contain, store, or maintain the logic or application described herein for use by or in connection with parameter server 120 and the clients 110.

The processing circuitry 300 may additionally include user interface components 350 including one or more displays and input devices. The user interface components 350 may include, for example, one or more display devices such as liquid crystal display (LCD) displays, gas plasma-based flat panel displays, organic light emitting diode (OLED) displays, electrophoretic ink (E ink) displays, LCD projectors, or other types of display devices, etc. Input devices may include a keyboard, mouse, handheld console, etc.

The features, structures, or characteristics described above may be combined in one or more embodiments in any suitable manner, and the features discussed in the various embodiments are interchangeable, if possible. In the following description, numerous specific details are provided in order to fully understand the embodiments of the present disclosure. However, a person skilled in the art will appreciate that the technical solution of the present disclosure may be practiced without one or more of the specific details, or other methods, components, materials, and the like may be employed. In other instances, well-known structures, materials, or operations are not shown or described in detail to avoid obscuring aspects of the present disclosure.

When relative terms such as “on,” “below,” “upper,” “lower,” “front,” “back,” and “rear” are used in the specification to describe the relative relationship of one component to another component, these terms are used in this specification for convenience only, for example, as a direction in relation to an orientation shown in the drawings. When a structure is “on” another structure, it is possible that the structure is integrally formed on another structure, or that the structure is “directly” disposed on another structure, or that the structure is “indirectly” disposed on the other structure through other structures.

In this specification, the terms such as “a,” “an,” “the,” and “said” are used to indicate the presence of one or more elements and components. The terms “comprise,” “include,” “have,” “contain,” and their variants are used to be open ended, and are meant to include additional elements, components, etc., in addition to the listed elements, components, etc. unless otherwise specified in the appended claims.

The terms “first,” “second,” etc. are used only as labels, rather than a limitation for a number of the objects. It is understood that if multiple components are shown, the components may be referred to as a “first” component, a “second” component, and so forth, to the extent applicable.

Disjunctive language such as the phrase “at least one of X, Y, or Z,” unless specifically stated otherwise, is understood as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, and at least one of Z to each be present.

The above-described embodiments of the present disclosure are merely possible examples of implementations set forth for a clear understanding of the principles of the disclosure. Many variations and modifications may be made to the above-described embodiment(s) without departing substantially from the principles of the disclosure. All such modifications and variations are intended to be included herein within the scope of this disclosure and protected by the following claims.

Therefore, the following is claimed:

1. A method comprising:
obtaining, as a local model at a client, a global model from a server;
performing a first training on the local model at the client using local data to update global parameters;
transmitting, from the client to the server, updates of the global parameters resulting from the first training; and
performing, subsequent to the transmitting, a second training at the client to generate a personalized model.

2. The method according to claim 1, further comprising:
transmitting, from the client to a reconfigurable intelligent surface (RIS) for reflection to the server, the updates of the global parameters resulting from the first training.

3. The method according to claim 2, further comprising:
designing phase shifts of the RIS.

4. The method according to claim 1, further comprising:
determining a number of steps in the first training based on a transmit power budget of the client.

5. The method according to claim 1, wherein
the transmitting the updates of the global parameters is simultaneous with transmissions from one or more additional clients to the server, and
the transmitting from the client and the transmissions from the one or more additional clients generate an updated global model at the server based on over-the-air aggregation of the updates of the global parameters from the client and the one or more additional clients.

6. The method according to claim 1, further comprising one or more iterations of:
receiving, as an updated local model at the client, the updated global model from the server;
performing the first training of the updated local model at the client to update the global parameters; and
transmitting, from the client to the server, updates of the global parameters resulting from the first training.

7. The method according to claim 6, wherein a number of the one or more iterations is based on convergence of the global model.

8. The method according to claim 1, wherein the performing the second training is on a result of the first training.

9. The method according to claim 1, wherein the client is one of a plurality of clients obtaining the global model from the server, performing the first training to update the global parameters, and transmitting the updates of the global parameters resulting from the first training to the server, and the method further comprises:
each of the plurality of clients using a respective reconfigurable intelligent surface (RIS) to reflect, to the server, the updates of the global parameters resulting from the first training.

10. The method according to claim 9, further comprising
each of the plurality of clients performing a respective number of steps in the first training that is based on an estimate of channel state information (CSI) at each of the plurality of clients, wherein
the number of steps in the first training performed by a first client among the plurality of clients is greater than the number of steps in the first training performed by a second client among the plurality of clients with a better estimate of CSI than the first client.

11. A system comprising:
a client configured to:
obtain, as a local model, a global model from a server;
perform a first training on the local model using local data to update global parameters;
transmit, to the server, updates of the global parameters resulting from the first training; and
perform, subsequent to transmitting the updates, a second training to generate a personalized model.

12. The system according to claim 11, wherein the client is further configured to transmit, to a reconfigurable intelligent surface (RIS) for reflection to the server, the updates of the global parameters resulting from the first training.

13. The system according to claim 12, wherein the client is further configured to design phase shifts of the RIS.

14. The system according to claim 11, wherein the client is further configured to determine a number of steps in the first training based on a transmit power budget of the client.

15. The system according to claim 11, wherein
the client is further configured to transmit the updates of the global parameters simultaneously with transmissions from one or more additional clients to the server, and
transmission from the client and the transmissions from the one or more additional clients generate an updated global model at the server based on over-the-air aggregation of the updates of the global parameters from the client and the one or more additional clients.

16. The system according to claim 11, wherein the client is further configured to perform one or more iterations of:
receiving, as an updated local model, the updated global model from the server;
performing the first training of the updated local model to update the global parameters; and
transmitting, to the server, updates of the global parameters resulting from the first training.

17. The system according to claim 16, wherein a number of the one or more iterations is based on convergence of the global model.

18. The system according to claim 11, wherein the client is configured to perform the second training on a result of the first training.

19. The system according to claim 11, wherein
the client is one of a plurality of clients configured to obtain the global model from the server, perform the first training to update the global parameters, and transmit the updates of the global parameters resulting from the first training to the server, and
each of the plurality of clients is additionally configured to use a respective reconfigurable intelligent surface (RIS) to reflect, to the server, the updates of the global parameters resulting from the first training.

20. The system according to claim 19, wherein
a number of steps in the first training performed by each of the plurality of clients is based on an estimate of channel state information (CSI) at each of the number of clients, and
the number of steps in the first training performed by a first client among the plurality of clients is greater than the number of steps in the first training performed by a second client among the plurality of clients with a better estimate of CSI than the first client.
